(19) United States
(12) Patent Application Publication
(10) Pub. No.: US 2025/0346691 A1
(43) Pub. Date: Nov. 13, 2025

(54) BIODEGRADABLE PLASTICS WITH ENHANCED SOLUBILITY

(71) Applicant: Culture Organics, LLC, Rye, NH (US)

(72) Inventor: James Reinertson, Rye, NH (US)

(21) Appl. No.: 19/201,304

(22) Filed: May 7, 2025

Related U.S. Application Data
(60) Provisional application No. 63/645,413, filed on May 10, 2024.
(60) Provisional application No. 63/701,655, filed on Oct. 1, 2024.

(51) Int. Cl. C08F 16/06; A01G 13/33; B65D 33/00; B65F 1/00; C08J 5/18; C08L 29/04

(52) U.S. Cl. CPC C08F 16/06; C08J 5/18; C08L 29/04; A01G 13/33; B65D 33/00; B65F 1/0006; C08J 2329/04; C08L 2201/06; C08L 2203/16

(57) ABSTRACT

Provided herein are biodegradable and sustainable polymeric compositions that include PVA, and articles made therefrom. The polymeric compositions described herein are useful in a wide range of industries; including commerce, and household.

### CROSS REFERENCE TO RELATED APPLICATIONS

The present invention claims priority to U.S. Provisional Application No. 63/645,413, filed May 10, 2024, and to U.S. Provisional Application No. 63/701,655, filed Oct. 1, 2024, which are hereby incorporated in their entireties including all tables, figures, and claims.

### BACKGROUND

Plastics are an indispensable part of modern society with numerous everyday applications in a wide range of industries, commerce, and household. This widespread use of plastics in our modern life has significantly increased their waste accumulation. Thus, making their disposal and recycling a prime waste management issue. To mitigate this problem, there is an immediate need to use plastics based on renewable resources and, with a zero-carbon footprint, for most, if not all applications. Provided herein are solutions to overcome these and other problems in the art by providing sustainable plastics and engineered polymers that may be used for a wide variety of applications such as medical, automobile, consumables, housekeeping, packaging, veterinary, pharmaceuticals, agriculture, construction, and the service industry.

### BRIEF SUMMARY

Provided herein, inter alia, are compositions comprising poly(vinyl alcohol) (PVA), a biodegradable, biocompatible, non-toxic, and water-soluble polymer with superior mechanical properties. Provided herein, inter alia, are also articles made with a composition comprising poly(vinyl alcohol) (PVA) wherein the articles are plastic free, non-toxic, biodegradable, and/or water-soluble.

In a first aspect described herein is a polymer composition comprising polyvinyl alcohol (PVA) and water, wherein the polymer composition may optionally include one or more additive(s). In an embodiment, the PVA is obtained from a bio-renewable resource. In another embodiment, the PVA is obtained from a bio-renewable resource including sugarcane. In one embodiment, the article is hydrophilic and, completely water soluble. In one embodiment, the article is 100% water soluble.

In an embodiment, the polymer composition includes 75-85% PVA, and 15-25% of water; or 70-90% PVA, and 10-30% of water; or 80% PVA, and 20% of water or 90% PVA, and 10% of water. In another embodiment, the article includes 70-90% PVA, and 10-30% of water.

In an embodiment, the polymer composition has a melt index (I2) in a range of from 1 to 5 g/10 minutes. In an embodiment, the polymer composition has a molecular weight distribution (M w/M n) in the range of from 1.2 to 2 g/mol.

In an embodiment, the polymer composition is stable between about 50° F. to 160° F.

In an embodiment, the article includes grocery bags, animal waste bags, dog waste collection bags, produce bags, gloves, packaging materials, films, shrink wrap films, pallet wraps, meat trays, clamshells, lunch trays, agricultural films, laundry pod shells, consumable medical products, or drug capsule shells. In an embodiment, the article is a pair of gloves.

In an embodiment, the article is a pallet wrap. In an embodiment, the pallet wrap has a moisture vapor transmission rate (WVTR) of less than 10 g/m2/day. In another embodiment, the pallet wrap has a moisture content of less than 0.5%. In another embodiment, the pallet wrap has a carbon footprint of 2.0 kg CO₂e per kilogram of wrap.

In an embodiment, the article is substantially soluble or completely soluble in water as a solvent (e.g., water-soluble). In an embodiment, an aqueous solution comprising the dissolved article is free of microplastics. Likewise, in an embodiment, the water containing the dissolved article is free of microplastics. In an embodiment, the polymer composition of the article described herein is recognized as Generally Recognized as Safe (GRAS).

In another aspect, a biodegradable collection bag is also described herein. The biodegradable collection bag includes a multilayer film, further comprising at least one layer of a polymer composition. The biodegradable collection bag further comprising an additional agent comprising a filler, a natural polymer material, or a plasticizer. In an embodiment, the additional agent is present in any of the layers of the multilayer film.

The polymer composition as described herein is about 65% to about 95% by weight of polyvinyl alcohol (PVA). In an embodiment, the PVA is sourced fully or partially from sugarcane or a derivative thereof. The biodegradable collection bag has a thickness of about 5 to 500 μm.

In an embodiment, the biodegradable collection bag further includes a filler. In another embodiment, the filler is present in any of the layers of the multilayer film. In another embodiment, the filler comprises olefin, polyethylene wax, silicon dioxide, talcum powder, calcium carbonate, magnesium carbonate, magnesium hydroxide, calcium stearate, titanium dioxide, lithopone, magnesium stearate, octadecanamide, stearic acid, or a combination thereof.

In an embodiment, the biodegradable collection bag further includes a natural polymer material. In another embodiment, the natural polymer material is present in any of the layers of the multilayer film. In another embodiment, the natural polymer material is cellulose, xylogen, starch, chitin, chitosan, a polysaccharide modifier, or a combination thereof. In an embodiment, the biodegradable collection bag further includes polylactic acid soluble cornstarch, and cassava.

In an embodiment, the biodegradable collection bag further includes a plasticizer, wherein the plasticizer is present in any of the layers of the multilayer film. In another embodiment, the plasticizer includes glycerol, diglycerol, polyethylene glycol, polypropylene glycol, caprolactam, trimethylolpropane, water, sorbitol, or a combination thereof.

In an embodiment, the biodegradable collection bag is toilet-flushable type. In another embodiment, the collection bag disintegrates under anaerobic conditions in 28 days. In another embodiment, the collection bag as described herein disintegrates in water with mechanical agitation.

In an embodiment, the biodegradable collection bag is completely soluble in water such that a water solution comprising the biodegradable collection bag is free of microplastics. In an embodiment, an aqueous solution comprising the biodegradable collection bag is ≥98% free of microplastics.

In an embodiment, the polymer composition of the biodegradable collection bag is recognized as Generally Recognized as Safe (GRAS).

### BRIEF DESCRIPTION OF THE DRAWINGS

FIG. 1 shows the drain clearance data of a sample (dog waste bag) made using an embodiment of the invention;

FIG. 2 shows the infrared spectral data of a sample (dog waste bag) made using an embodiment of the invention; and

FIG. 3 shows the ATR-IR spectrum of Sugarcane PVA Resin (Granular Code: 2024RSG).

### DEFINITIONS

All publications, patents and patent applications cited herein, whether supra or infra, are hereby incorporated by reference in their entirety to the same extent as if each individual publication, patent, or patent application were specifically and individually indicated to be incorporated by reference.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary.

The term “or,” unless stated otherwise, refers to the listed members individually as well as in any combination. Use of the singular includes use of the plural and vice versa.

The terms “a,” “an,” “the” and similar referents used in the context of describing the inventive features (especially in the context of the following claims) are to be construed to cover both the singular and the plural, unless otherwise indicated herein or clearly contradicted by context. Thus, for example, reference to a “starch” may include one, two or more starches.

A “polymer” is a composition prepared by polymerizing monomers and/or individual components, whether of the same or a different type, that in polymerized form provide the multiple and/or repeating “units” or “mer units” that make up a polymer. The individual components within the polymer may also include polymers.

PVA is defined herein includes “PVA sugarcane.” For example, the PVA described herein, may be in whole or in part PVA sugarcane. “PVA sugarcane,” as used herein is not derived from fossil fuels, is fully biodegradable, has a defined end-of-life, and/or is environmentally friendly. The use of PVA sugarcane for certain embodiments herein further support sustainability, flush ability, and have a positive environmental impact.

The term “flush ability,” as used herein determines the ability of any article to be flushed down a toilet or a comparable system, for example, any waste drainage system.

The term “solate,” as used herein is the process of liquefying a gel, or the act of forming a sol from a gel.

The term “completely soluble,” as used herein, refers to a solute being soluble to the extent that less than 0.001% of the solute remains in the solvent after dissolution.

“Film,” as used herein, refers to a continuous article made of one or multiple layers that includes one or more polymeric materials that may be used to separate areas or volumes, to hold items, to act as a barrier, and/or as a printable surface.

“Bag,” as used herein, refers to a container made of a flexible film that may be used for containing and/or transporting goods which are perishable or non-perishable in nature. A “collection bag,” as used herein, refers to a bag used to collect waste, for example, any animal waste including dog waste.

“Bottle,” as used herein, refers to a container that may be made from the presently disclosed polymer composition, typically of a thickness greater than a film, and which typically includes a relatively narrow neck adjacent an opening. Such bottles may be used to hold a wide variety of products (e.g., beverages, personal care products such as shampoo, conditioner, lotion, soap, cleaners, and the like).

“Microplastics,” as used herein are fragments of any type of plastic less than 5 mm in length including primary microplastics and secondary microplastics. A s used herein, it may also include “nano plastics.”

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical manufacturing process, and may include values that are within 25%, 15%, 10%, within 5%, within 1%, etc. of a stated value.

The phrase ‘free of’ or similar phrases as used herein means that the composition comprises 0% of the stated component, that is, the component has not been intentionally added to the composition. However, it will be appreciated that such components may incidentally form under appropriate circumstances, may be incidentally present within another included component, e.g., as an incidental contaminant, or the like.

The term “Mn” used herein and in the appended claims in reference to a polymer of the present invention is the number average molecular weight of the block copolymer (in g/mol) determined according to the method used herein or as per industry standards.

The term “Mw” used herein and in the appended claims in reference to a polymer of the present invention is the weight average molecular weight of the polymer (in g/mol) determined according to the method used herein or as per industry standards.

### Test Methods

Melt index (MI) (I2) in g/10 min may be measured using ASTM D-1238-04 (190° C./2.16 kg).

### Detailed Description

### Compositions

Provided herein are compositions used in the manufacture of grocery store bags, produce bags, pet pee pads; medical industry consumables including IV bags, blood pillows, gloves, hairnets, booties, gowns; packaging materials including medical packaging, shrink wrap films, meat trays, clamshells, lunch trays, cups, cutlery, agricultural films, laundry pod shells, laundry bags, pallet wraps; consumable medical and/or other products, drug capsule shells, bottles including baby milk bottles, or pill bottles.

In an embodiment, the polymer composition described herein is a hydrogel. In an embodiment, the polymer composition described herein is completely water soluble. In an embodiment, the polymer composition described herein is 100% water soluble. In an embodiment, the polymer composition is soluble in water to the extent that less than 0.001% of the polymer composition remains in the water after complete dissolution.

In an embodiment, the dissolution index (DI) of the polymer composition is calculated as follows: DI=(Rate of PVA dissolution)/(Time for complete dissolution). In an embodiment, the polymer composition has a Dissolution Index (DI) between about 0.1 to about 10, about 0.2 to about 10, about 0.3 to about 5.0, or about 0.5 to about 5.0.

In an embodiment, the polymer composition has a Dissolution Index (DI) greater than about 0.5, greater than about 0.6, greater than about 0.7, greater than about 0.8, greater than about 0.9, greater than about 1.0, or greater than about 1.5, greater than about 2.5, greater than about 5.0.

In an embodiment, the polymer composition described herein is completely soluble in water such that the water containing the polymer composition is free of plastics and/or microplastics. In an embodiment, the water is free from other contaminants.

In an embodiment, the microplastics include plastic fragments less than 5 mm in length. In an embodiment, the microplastics include plastic fragments less than 1 μm in length.

In an embodiment, the polymer composition also known as the ‘solute,’ when dissolved in water, also known as the ‘solvent,’ is completely dissolved. In an embodiment, the solvent that contains the completely dissolved polymer composition is free of microplastics.

In an embodiment, the compositions described herein includes PVA as shown in formula I:

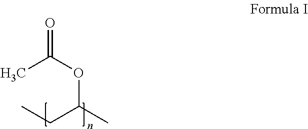

In an embodiment, the PVA is sourced from a bio-renewable resource including biomass. In another embodiment, the PVA is not sourced from a non-renewable resource.

In an embodiment, the PVA is sourced, fully or partially, from sugarcane or a derivative thereof.

In an embodiment, the PVA is present in an amount of greater than about 50 wt. %, or greater than about 60 wt. %, or greater than about 70 wt. % or greater than about 80 wt. % or greater than about 90 wt. %.

In an embodiment, the PVA is present in an amount of about 50 wt. %, 55 wt. %, 60 wt. %, 65 wt. %, 70 wt. %, 75 wt. %, 80 wt. %, 85 wt. %, 90 wt. %, or 95 wt. %.

In an embodiment, the water is present in an amount of less than about 50 wt. %, or less than about 40 wt. %, or less than about 30 wt. % or less than about 20 wt. % or less than about 10 wt. % or less than about 5 wt. %.

In an embodiment, the water is present in an amount of about 50 wt. %, 45 wt. %, 40 wt. %, 35 wt. %, 30 wt. %, 25 wt. %, 20 wt. %, 15 wt. %, 10 wt. %, or 5 wt. %.

In an embodiment, the polymer composition comprises about 75-85% PVA, and about 15-25% of water; or about 70-90% PVA, and about 10-30% of water; or about 80% PVA, and about 20% of water; or about 90% PVA, and about 10% of water.

In an embodiment, the polymer composition comprises about 60-95% PVA, and about 5-35% of water.

In an embodiment, the polymer composition is biodegradable.

In an embodiment, the polymer composition when dissolved in water is completely water soluble. The solubility in water or any other solvent depends on its degree of hydrolysis, degree of polymerization and degree of heat treatment received during the manufacturing process. In an embodiment, the solubility in water improves with increased degree of hydrolysis. In an embodiment, the solubility in water improves with heat.

In an embodiment, the polymer composition optionally includes one or more additives, including plasticizers, flame retardants, antioxidants, acid scavengers, light and heat stabilizers, antioxidants, lubricants, pigments, antistatic agents, slip compounds, curing agents, fillers, pigments, soluble colorants, blowing agents, biocides, and thermal stabilizers. In an embodiment, the additive may be used alone or in combination with another additive. Furthermore, the additive is chosen such that the addition of one or more additives does not hamper water solubility of the polymer composition.

In an embodiment, the polymer composition optionally includes plasticizers such as water, or glycerol. In an embodiment, the polymer composition optionally includes fillers such as cellulose nanofibers, chitosan, or feather keratin. In an embodiment, the additives are antioxidants or UV stabilizers.

In an embodiment, the polymer composition optionally includes a processing aid or a slip agent for example, one or more selected from an oleic acid amide, erucic acid amide, polysiloxane, or a combination thereof.

In an embodiment, the polymer composition optionally includes a filling agent. The filling agent used can be a general filling agent in the film process, for example, one or more selected from olefin, polyethylene wax, silicon dioxide, talcum powder, calcium carbonate, magnesium carbonate, magnesium hydroxide, calcium stearate, titanium dioxide, lithopone, magnesium stearate, octadecanamide, or stearic acid. In some embodiments, the filling agent is present in an amount of about 1 wt. % to about 25 wt. %, about 2 wt. % to about 20 wt. %, about 2 wt. % to about 15 wt. %, about 3 wt. % to about 10 wt. %, or about 5 wt. % to about 10 wt. %.

In an embodiment, the polymer composition optionally includes a natural polymer material. In an embodiment, the natural polymer material comprises cellulose, xylogen, starch, chitin, chitosan, a polysaccharide modifier, or a combination thereof. In an embodiment, the biodegradable collection bag further includes polylactic acid soluble cornstarch, and cassava.

In an embodiment, the plasticizer used is a commonly used plasticizer for PVA based film, for example, one or more selected from glycerol, diglycerol, polyethylene glycol, polypropylene glycol, caprolactam, trimethylolpropane, water, sorbitol, or glycerol.

In an embodiment, the plasticizer is present in an amount of about 5 wt. % to 50 wt. %. In another embodiment, the plasticizer is present in an amount of about 8 wt. % to 40 wt. %. In another embodiment, the plasticizer is present in an amount of about 10 wt. % to 30 wt. %. In another embodiment, the plasticizer is present in an amount of about 12 wt. % to 25 wt. %. In another embodiment, the plasticizer is present in an amount of about 15 wt. % to 25 wt. %. In another embodiment, the plasticizer is present in an amount of about 15 wt. % to 20 wt. %. In another embodiment, the plasticizer is present in an amount of about 20 wt. % to 25 wt. %.

In an embodiment, the optional agents and/or additives are individually present in an amount of about 1 wt. % to 50 wt. %. In another embodiment, the optional agents are individually present in an amount of about 10 wt. % to 30 wt. %. In another embodiment, the optional agents are individually present in an amount of about 15 wt. % to 25 wt. %. Furthermore, the additives and/or optional agents are chosen such that their addition does not hamper water solubility of the polymer composition.

### Articles

Provided herein are articles formed using the polymeric composition as described above and throughout the specification. In an embodiment, the articles include grocery store bags, T-shirt bags, produce bags, pet pee pads; medical industry consumables including IV bags, blood pillows, gloves, hairnets, booties, gowns; packaging materials including medical packaging, shrink wrap films, meat trays, clamshells, lunch trays, cups, cutlery, agricultural films, laundry pod shells, laundry bags, pallet wraps; consumable medical and/or other products, drug capsule shells, bottles including baby milk bottles, or pill bottles. In an embodiment, the articles include credit cards, gift cards, security cards, hotel room keycards or identification cards. In an embodiment, the articles described herein are completely water soluble.

In an embodiment, the articles have a melt index (I₂) in a range of from about 0.1 to about 10 g/10 minutes as measured by A STDM standards. In another embodiment, the articles have a melt index (I₂) in a range of from about 0.5 to about 8 g/10 minutes as measured by ASTDM standards. In another embodiment, the articles have a melt index (I₂) in a range of from about 2.0 to about 7 g/10 minutes as measured by ASTDM standards. In another embodiment, the articles have a melt index (I₂) in a range of from about 1.0 to about 7 g/10 minutes as measured by ASTDM standards.

In an embodiment, the articles have a melt index (I₂) in a range of from about 1.0 to about 6 g/10 minutes as measured by A STDM standards. In another embodiment, the articles have a melt index (I₂) in a range of from about 1.5 to about 6 g/10 minutes as measured by ASTDM standards. In another embodiment, the articles have a melt index (I₂) in a range of from about 1.2 to about 5 g/10 minutes as measured by ASTDM standards.

In an embodiment, the articles have a melt index (I₂) in a range of from about 0.5 to about 6 g/10 minutes as measured by ASTDM standards. In another embodiment, the articles have a melt index (I₂) in a range of from about 0.8 to about 6 g/10 minutes as measured by ASTDM standards. In another embodiment, the articles have a melt index (I₂) in a range of from about 0.8 to about 5.5 g/10 minutes as measured by ASTDM standards. In another embodiment, the articles have a melt index (I₂) in a range of from about 1.0 to about 5.5 g/10 minutes as measured by ASTDM standards.

In another embodiment, the articles have a melt index (I₂) in a range of from about 1.1 to about 5.3 g/10 minutes as measured by ASTDM standards. In another embodiment, the articles have a melt index (I₂) in a range of from about 1.1 to about 5.2 g/10 minutes as measured by ASTDM standards. In another embodiment, the articles have a melt index (I₂) in a range of from about 1 to about 5 g/10 minutes as measured by ASTDM standards.

In an embodiment, the articles have a molecular weight distribution (M_{w}/Mₙ) in the range of from about 0.1 to about 30 g/mol. In another embodiment, the articles have a molecular weight distribution (M_{w}/Mₙ) in the range of from about 0.5 to about 20 g/mol. In another embodiment, the articles have a molecular weight distribution (M_{w}/Mₙ) in the range of from about 0.5 to about 15 g/mol. In another embodiment, the articles have a molecular weight distribution (M_{w}/Mₙ) in the range of from about 1.0 to about 5 g/mol.

In another embodiment, the articles have a molecular weight distribution (M_{w}/Mₙ) in the range of from about 0.5 to about 10 g/mol. In another embodiment, the articles have a molecular weight distribution (M_{w}/Mₙ) in the range of from about 0.8 to about 8 g/mol. In another embodiment, the articles have a molecular weight distribution (M_{w}/Mₙ) in the range of from about 0.5 to about 5 g/mol.

In another embodiment, the articles have a molecular weight distribution (M_{w}/Mₙ) in the range of from about 0.8 to about 3 g/mol. In another embodiment, the articles have a molecular weight distribution (M_{w}/Mₙ) in the range of from about 1.0 to about 2 g/mol. In another embodiment, the articles have a molecular weight distribution (M_{w}/Mₙ) in the range of from about 1.1 to about 2.5 g/mol. In another embodiment, the articles have a molecular weight distribution (M_{w}/Mₙ) in the range of from about 1.1 to about 2 g/mol.

In an embodiment, the article is a biodegradable bag. In another embodiment, the article is a biodegradable collection bag. In another embodiment, the article is a biodegradable waste collection bag, for example a collection bag used to collect animal waste.

In an embodiment, the article is a film with a thickness measured in microns or micrometers (μm). In an embodiment, the film has a thickness of about of about 1 μm to 500 μm. In an embodiment, the film has a thickness of about of about 5 μm to 400 μm. In an embodiment, the film has a thickness of about of about 10 μm to 300 μm. In an embodiment, the film has a thickness of about of about 10 μm to 100 μm.

In an embodiment, the film has a thickness of about of about 5 μm to 150 μm. In an embodiment, the film has a thickness of about of about 10 μm to 100 μm. In an embodiment, the film has a thickness of about of about 15 μm to 80 μm. In an embodiment, the film has a thickness of about of about 20 μm to 50 μm.

In an embodiment, the article is a multilayer film with a thickness measured in microns or micrometers (μm). In an embodiment, the article has at least one layer including a polymer composition described herein. In another embodiment, the article has other optional layers that include one or more layers of fillers, natural polymer material, plasticizers, other optional agents, or a combination thereof.

In one embodiment, one or more of the fillers, natural polymer materials or plasticizers are present in separate layers. In another embodiment, one or more of the fillers, natural polymer materials or plasticizers are present in the same layer. In another embodiment, one or more of the fillers, natural polymer materials or plasticizers are present in the layer comprising the polymer composition described herein.

In an embodiment, the compositions and/or articles described herein are biodegradable. In another embodiment, the articles described herein are flushable through the toilet. In another embodiment, the articles described herein successfully clear the toilet and drainage lines in a commercial and/or residential building property. In another embodiment, the articles described herein are designed for flushing down the toilet (i.e., having improved flush ability). In an embodiment, the biodegradable collection bag is toilet-flushable type. In an embodiment, the biodegradable collection bag described herein disintegrates when subjected to mechanical agitation in water.

In an embodiment, the flush ability of the article described herein can be improved by solvation and/or solation. In another embodiment, the flush ability of the article described herein is improved by solvation. In another embodiment, the flush ability of the article described herein is improved by solation.

In an embodiment the article described herein can solvate. In another embodiment, the article can solvate in water. In another embodiment, the article can solate. In another embodiment, the article is converted from a gel to a sol.

In an embodiment, the compositions and/or articles described herein disintegrate when subjected to mechanical agitation in water. In another embodiment, the articles described herein disintegrate when subjected to wastewater. In an embodiment, the biodegradable collection bag described herein disintegrates when subjected to mechanical agitation in water.

In an embodiment, the compositions and/or articles described herein settle in sumps, septic tanks, onsite aerobic systems and settling chambers that are associated with pump stations and municipal wastewater treatment plants.

In an embodiment, the compositions and/or articles described herein are completely degraded in a drain. For example, a waste collectible bag according to an embodiment of the invention can be flushed down the drain. In another embodiment, the waste collectible bag completely disintegrates in the drain.

In an embodiment, the compositions and/or articles described herein biologically disintegrate under anaerobic conditions found in sewers as well as municipal and onsite wastewater treatment systems. In an embodiment, the biodegradable collection bag described herein disintegrates under anaerobic conditions.

The compositions and/or articles described herein can be moved down the drain-line and passed the center of mass criteria for the Toilet Bowl and Drain-line Clearance Test. In an embodiment, the article described herein moves down the drain-line within 24 hours. In another embodiment, the article described herein moves down the drain-line within 10 hours. In another embodiment, the article described herein moves down the drain-line within 1 hour. In another embodiment, the article described herein moves down the drain-line within 30 minutes. In another embodiment, the article described herein moves down the drain-line within 10 minutes.

In another embodiment, the compositions and/or articles described herein disintegrate under anaerobic conditions within 1 to 60 days. In another embodiment, the compositions and/or articles described herein disintegrate under anaerobic conditions within 20 days. In another embodiment, the compositions and/or articles described herein disintegrate under anaerobic conditions within 15 days. In another embodiment, the compositions and/or articles described herein disintegrate under anaerobic conditions within 10 days. In another embodiment, the compositions and/or articles described herein disintegrate under anaerobic conditions within 5 days. In another embodiment, the compositions and/or articles described herein disintegrate under anaerobic conditions in 28 days.

In an embodiment, the compositions and/or articles described herein can be completely degraded in a landfill. In another embodiment, the compositions and/or articles described herein can be degraded in landfill within 10 to 20 days. In another embodiment, the compositions and/or articles described herein can be degraded in landfill by 20 days. In another embodiment, the compositions and/or articles described herein can be degraded in landfill by 19 days. In another embodiment, the compositions and/or articles described herein can be degraded in landfills by 18 days. In another embodiment, the compositions and/or articles described herein can be degraded in landfill by 17 days. In another embodiment, the compositions and/or articles described herein can be degraded in landfill by 16 days. In another embodiment, the compositions and/or articles described herein can be degraded in landfill by 15 days.

In an embodiment, the articles described herein are completely soluble in water or other comparable polar solvents.

In an embodiment, the article is stable between about 50° F. to 160° F. or between about 50° F. to 165° F. or between about 55° F. to 165° F. or between about 55° F. to 155° F. or between about 60° F. to 150° F.

In an embodiment, the article is stable between about 50° F. to 160° F.

In an embodiment, the article disintegrates at a temperature below about 50° F. In an embodiment, the article disintegrates at a temperature above about 160° F.

In an embodiment, the article disintegrates at a temperature below about 55° F. or below about 50° F. or below about 45° F. or below about 40° F. or below 3 about 5° F. or below about 30° F.

In an embodiment, the article disintegrates at a temperature above about 150° F. or above about 155° F. or above about 160° F. or above about 165° F.

In an embodiment, the article is a pair of gloves. In an embodiment, the gloves have a thickness of about 0.1 to 100 mils. In an embodiment, the gloves have a thickness of about 0.5 to 50 mils. In an embodiment, the gloves have a thickness of about 1 to 10 mils. In an embodiment, the gloves have a thickness of about 1 to 5 mils. Note: a mil is a measurement that equals one-thousandth of an inch, or 0.001 inch. One mil also equals 0.0254 mm (millimeter).

In an embodiment, the gloves have a thickness of about 0.5 to 5 mils. In an embodiment, the gloves have a thickness of about 0.5 to 2.5 mils. In an embodiment, the gloves have a thickness of about 0.5 to 2 mils. In an embodiment, the gloves have a thickness of about 1 to 2 mils. In an embodiment, the gloves have a thickness of about 1 to 2.5 mils. In an embodiment, the gloves have a thickness of about 1.5 to 2.5 mils.

In an embodiment, the article has a tensile strength of about 5 to 500 M Pa or 10 to 300 M Pa, or 15 to 200 M Pa, or 20 to 200 M Pa, or 25 to 150 M Pa, or 30 to 100 M Pa, or 40 to 75 M Pa, or 45 to 60 M Pa, or 45 to 50 M Pa.

In an embodiment, the article has a Young's modulus is about 0.5 to 50 GPa, or about 1 to 25 GPa, or about 1.5 to 20 GPa, or about 2.5 to 15 GPa, or about 2 to 20 GPa, or about 2 to 10 GPa, or about 2 to 5 GPa.

In an embodiment, the article has a Young's modulus of about 5 to 1500 M Pa, or 10 to 1500 M Pa, or 10 to 1000 M Pa, or 50 to 1000 M Pa, or 75 to 800 M Pa, or 80 to 800 M Pa, or 100 to 1500 M Pa, or 150 to 1000 M Pa, or 200 to 1000 M Pa, or 250 to 900 M Pa, or 300 to 900 M Pa, or 350 to 800 M Pa, or 400 to 800 M Pa, or 450 to 800 M Pa, or 500 to 800 M Pa, or 550 to 800, or 600 to 800 M Pa, or 650 to 800 M Pa, or 700 to 800 M Pa, or 700 to 750 M Pa.

In an embodiment, the article is a packaging material. In another embodiment, the article is a pallet wrap. The pallet wrap has a low carbon footprint. In an embodiment, carbon footprint for the pallet wrap is about 1.5 to about 2.0 kg CO₂e per kilogram of wrap. In another embodiment, carbon footprint for the pallet wrap is less than 2.0 kg CO₂e per kilogram of wrap. In another embodiment, carbon footprint for the pallet wrap is less than 1.5 kg CO₂e per kilogram of wrap. In another embodiment, carbon footprint for the pallet wrap is 2.0 kg CO₂e per kilogram of wrap.

In an embodiment, the pallet wrap has a shelf-life greater than 12 months. In an embodiment, the pallet wrap has a shelf-life of about 12 months. In another embodiment, the pallet wrap has a shelf-life of about 14 months. In another embodiment, the pallet wrap has a shelf-life of about 16 months.

In an embodiment, the pallet wrap has a moisture vapor transmission rate (WVTR) of less than 10 g/m²/day. In another embodiment, the pallet wrap has a moisture vapor transmission rate (WVTR) of 8 g/m²/day.

In an embodiment, the pallet wrap has a moisture content of less than 0.5% as determined by ASTM D 6980 (Standard Test Method for Determination of Moisture in Plastics by Loss in Weight). In another embodiment, the pallet wrap has a moisture content of less than 0.4%. In another embodiment, the pallet wrap has a moisture content of less than 0.3%. In another embodiment, the pallet wrap has a moisture content of less than 0.2%. In another embodiment, the pallet wrap has a moisture content of less than 0.1%.

In an embodiment, the article described herein is completely soluble in water or a comparable solvent. In an embodiment the solvent containing the completely soluble article is free of microplastics.

In an embodiment, the article also known as the ‘solute,’ when dissolved in water, also known as the ‘solvent,’ is completely dissolved. In an embodiment, the water that contains the completely dissolved article is free of microplastics.

In an embodiment, the articles described herein are free of microplastics when contacted or dissolved in one or more polar solvents.

In an embodiment, the article is a toilet-flushable type biodegradable collection bag.

In an embodiment, the bag as described herein has a thickness of about 1 μm to 5000 μm, about 1 μm to 4000 μm, about 1 μm to 3000 μm, about 1 μm to 2000 μm, or about 1 μm to 1000 μm. In another embodiment, the bag has a thickness of about 10 to about 900 μm, about 10 to about 800 μm, about 10 to about 700 μm, about 10 to about 600 μm, or about 10 to about 500 μm. In another embodiment, the bag has a thickness of about 50 to about 500 μm. In another embodiment, the bag has a thickness of about 1 μm to about 500 μm. In an embodiment, the bag has a thickness of about 50 μm to about 400 μm, about 50 μm to about 300 μm, about 50 μm to about 250 μm, about 50 μm to about 200 μm, about 50 μm to about 150 μm, or about 50 μm to about 100 μm.

In an embodiment, the bag as described herein has a thickness of about 0.1 to about 100 mils, about 0.1 to about 90 mils, about 0.1 to about 80 mils, about 0.1 to about 70 mils, about 0.1 to about 60 mils, about 0.1 to about 50 mils. In another embodiment, the bag has a thickness of about 0.5 to about 50 mils, about 0.5 to about 40 mils, about 0.5 to about 30 mils, about 0.5 to about 20 mils, or about 0.5 to about 10 mils. In another embodiment, the bag has a thickness of about 1 to about 10 mils, about 1 to about 9 mils, about 1 to about 8 mils, about 1 to about 7 mils, about 1 to about 6 mils, or about 1 to about 5 mils. In an embodiment, the bag has a thickness of about 1 to about 5 mils, about 2 to about 4 mils, or about 3 mils.

In an embodiment, the bag containing pet waste maintains excellent strength and water-resistance before being disposed or discarded through the toilet.

In an embodiment, the bag also known as the ‘solute,’ when dissolved in water, also known as the ‘solvent,’ is ≥95% dissolved, ≥96% dissolved, ≥97% dissolved, ≥98% dissolved, ≥99% dissolved, ≥99.9% dissolved, or 100% dissolved (i.e., completely dissolved). In an embodiment, the water that contains the dissolved bag is ≥95%, ≥96%, ≥97%, ≥98%, ≥99%, ≥99.9%, or 100% free of microplastics (i.e., completely free of microplastics).

In an embodiment, the bag as described herein is free of microplastics when dissolved in one or more polar solvents. In an embodiment, the microplastics include plastic fragments less than 5 mm in length. In an embodiment, the microplastics include plastic fragments less than 1 μm in length.

### Methods

Provided herein is a method of manufacturing an article from the polymeric composition described herein. The method includes providing a machine used for LLDPE (Linear Low-Density Polyethylene) film production comprising a motor with at least 25 kilowatts power; cleaning the machine; setting a desired temperature; introducing a predetermined ratio of individual components into an extruder; wherein the components comprise of polyvinyl alcohol (PVA) derived from a sugarcane source; and water; wherein the PVA obtained from the sugarcane source is without any microbial fermentation; and forming the film. In an embodiment, the PVA is present in an amount of about 70-90% and the water is present in an amount of about 10-30%. In an embodiment, the L/D (Length-to-Diameter) ratio of the machine is 28:1 and the motor has a power greater than 25 kilowatts.

In an embodiment, the desired temperature for the manufacturing of an article is about 0° C. to 250° C., 200° C. to 250° C., 210° C. to 240° C., 220° C. to 230° C., or 215° C. to 225° C. In an embodiment, the desired temperature is about 215°° C., or 220° C., or 230°° C., 235° C. or 240° C. or 245° C.

In an embodiment, the desired temperature is about 215° C. or about 225° C.

### EXAMPLES

### Example 1: Method to Make an Article from PVA

To manufacture a film, use an extruder suitable for LLDPE manufacturing with at least 25 kilowatts power. Adjust the temperature of the extruder to about 220° C. during the heating phase. Introduce 70-90 wt. % of PVA and 10-30 wt. % of water into the extruder as soon as the temperature reaches 220° C. Remove the barrel baffle (if present). Examine the product (polymeric material) that is extruded to check for complete plasticization. If the product is completely plasticized proceed to blow the film. Manufacture various articles as need be from the extruded film. A film formed using the methods above may be a single layer film or a multilayer film having a varied thickness of about 5 to 500 μm.

### Example 2: Properties of an Article for Example, a Dog Waste Bag)

The following tests were performed to determine the properties of the article (dog waste bag)

### Example 2A: Toilet Bowl and Drain-Line Clearance Test (GD4)

This method is used to determine the flush ability of the article (dog waste bag/07292024 sample number), i.e., the likelihood that a product will successfully clear the toilet and drainage lines in a building. The sample was tested on a Kohler Cimarron toilet connected to a 100 mm (four inch) clear PVC piping, 22.15 meters in length with a 2% slope, including two ninety-degree turns at 5 and 14 meters, two forty-five degree turns at 7 and 7.5 meters, and marked every 0.5 meters. The flush volume is about six liters (1.6 gallons) or less, which is checked prior to testing and immediately after conclusion of testing. One bag was used in the flushing sequence. The dimensions of the bags used were 232 mm×317 mm. The baseline data and validation was conducted with six sheets of a 4-inch-by-4-inch Quilted Northern bath tissue (unit dose) and Simulated Fecal Matter (SFM), and showed that the current toilet and drain-line configuration consistently moved product down the drain-line and passed the Center of Mass criteria for the Toilet Bowl and Drain-line Clearance Test method FG501. The bag sample was opened to its full capacity and then folded twice before it was added to the toilet bowl. The bag and toilet paper were allowed to fully wet out before flushing them.

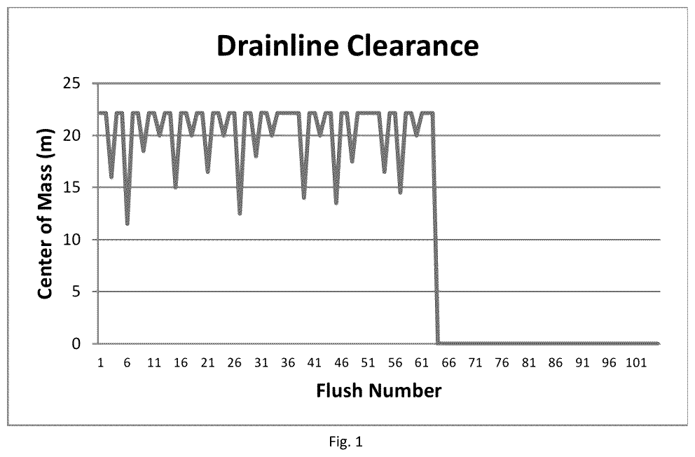

The 07292024 sample passed the FG501—Toilet Bowl and Drain-line Clearance test. No toilet bowl clogs were observed, and the samples continued to pass down the drain-line system. The bag sample was almost completely dissolved by the time it made it through the 22.15-meter drain-line system. The summarized results of the submitted sample are in Table 1 and FIG. 1.

TABLE 1

| | | IPS | | | | | |
|---|---|---|---|---|---|---|---|
| | | Balances: | IPS-0873 | IPS-1704 | | | |
| Test | Aug. 8, 2024 | TP | Weight | | | Weight | |
| Date: | NJS | Unit # | (g) | | SFM # | (g) | |
| Run by: | | 1 | 2.67 | | 1 | 52.62 | |
| | | 2 | 2.68 | | 2 | 53.24 | |
| Toilet | Quilted | 3 | 2.68 | | 3 | 53.19 | |
| Paper | Northern | | | | | | |
| (TP) [symbol] | 2.68 | | | | | | |
| Ave Mass | | Ave | 2.68 | | Ave | 53.02 | |
| of TP: | | | | | | | |
| | | SD | 0.0058 | | SD | 0.3444 | |
| | | | | | | Weight | Loading # |
| | | | | | | (g) | |
| SFM [symbol] | | | Starting flush volume* | | 3 pieces of SFM: | 159.05 | |
| | Feclone | | | | | | |
| Ave Mass | BFPS-7 | | Weight | Volume | | | |
| of SFM: | 53.02 | Flush # | (g) | (gallon) | | | |
| | | 1 | 5366.2 | 1.42 | 1 unit dose | 2.68 | T2-1 |
| Bags used: | 1 | 2 | 5312.2 | 1.40 | of TP | | |
| Ave DW | 4.83 | 3 | 5401.3 | 1.43 | 2 unit doses | 164.40 | T2-5 |
| wipe | | | | | TP + 3 [symbol] | | |
| Bag Dry | Weight (g) | Ave | 5359.9 | 1.41 | | | |
| Weight | | | | | | | |
| 1 | | SD | 44.8828 | 0.0118 | I unit dose | 7.51 | T4-1 + 3 |
| 2 | 4.87 | | | | TP + # [symbol] | | |
| 3 | 5.06 | | | | 3 SFM + 2 | 169.24 | T4-5 |
| | | | | | UD + # [symbol] | | |
| 4 | 4.51 | | Ending flush volume* | | | | |
| 5 | 4.91 | Flush | Weight (g) | Volume | | | |
| | | [symbol] | | [symbol] | | | |
| 6 | 5.06 | 1 | 5326.9 | 1.41 | | | |
| 7 | 5.33 | 2 | 5369.8 | 1.42 | | | |
| 8 | 5.01 | 3 | 5379.4 | 1.42 | | | |
| | 4.51 | Ave | 5358.7 | 1.41 | | | |
| 9 | 4.67 | SD | 27.9548 | 0.0074 | | | |
| 10 | 4.42 | | | | | | |
| Ave DW | 4.83 | | | | | | |
| mass: | | | | | | | |

| | | |
|---|---|---|
| SD | 0.2956 | *Range: 5009 g to 5609 g |

[symbol]

indicates data missing or illegible when filed

### Example 2B: Disintegration of the Article (Dog Waste Bag)

This method is used to assess the potential for a product to disintegrate when it is subjected to mechanical agitation in water or wastewater (optional). In this example, one bag sample (#07292024) was placed in the slosh box in four liters of 20° C.±2° C. tap water in the method specified three-compartment slosh box for two rounds of testing. The temperatures of the room and the tap water are taken before and after the testing procedure. The slosh box was set to eighteen rpm and allowed to agitate for thirty minutes. The bag samples were agitated in five replicates as described in the method. The slosh box contents were poured through a 25-mm sieve with a blank spacer ring beneath it, and rinsed for one minute with a hand sprayer at a rate of four liters per minute. The remaining products were carefully placed in a tared aluminum pan, dried in a 105° C. oven and statistically compared to the average dry weight of five bag samples.

The 07292024 sample passed the IWSFG PAS3:2020—Slosh Box Disintegration Test method criteria of >80% passing through the 25-mm sieve. The samples were not pre-rinsed according to the method, as this step would lead to the partial dissolving of the sample and not being able to transfer them into the slosh box compartments. The results are summarized in Table 2.

### Rock Angle Measurement

Date of last measurement: Jul. 15, 2024
Degrees to front: 11.1
Degrees to back: 11.0
Digital Level: IPS-0787
Analyst: NJS
Dimensions (mm): 232 mm×317 mm

TABLE 2

| | | | | Start | End | Start | End |
|---|---|---|---|---|---|---|---|
| | Time | | | Lab | Lab | Water | Water |
| Sample | (min.) | | 25 mm | Temp | Temp | Temp | Temp |
| 01322-24-001 | 30 min. | | 0.0000 | 21.5° C. | 21.5° C. | 19.8° C. | 20.3° C. |
| | 30 min. | | 0.0000 | 21.5° C. | 21.5° C. | 19.8° C. | 20.3° C. |
| | 30 min. | | 0.0000 | 21.5° C. | 21.5° C. | 19.8° C. | 20.3° C. |
| | 30 min. | | 0.0000 | 21.5° C. | 21.5° C. | 19.8° C. | 20.3° C. |
| | 30 min. | | 0.0000 | 21.5° C. | 21.5° C. | 19.8° C. | 20.3° C. |
| | | SUM | 0.0000 | | | | |

TABLE 3

| | Time | | | | | Pan | OD + | Dried |
|---|---|---|---|---|---|---|---|---|
| Sample | (min.) | | % <25 mm | | Bag # | Tare (g) | Pan (g) | Bag (g) |
| 01322-24-001 | 30 min. | | | | 1 | 1.0000 | 1.0000 | 0.0000 |
| | 30 min. | | | | 2 | 1.0000 | 1.0000 | 0.0000 |
| | 30 min. | | | | 3 | 1.0000 | 1.0000 | 0.0000 |
| | 30 min. | | | | 4 | 1.0000 | 1.0000 | 0.0000 |
| | 30 min. | | | | 5 | 1.0000 | 1.0000 | 0.0000 |
| | | % thru | 100.0% | Pass | | | | |
| | | sieve | | | | | | |

### Example 2C: Settling Capacity of the Article (Dog Waste Bag)

The purpose of this test is to assess whether a product (sample #07292024) settles in sumps, septic tanks, onsite aerobic systems and settling chambers that are associated with pump stations and municipal wastewater treatment plants. Ten replicates, each four-inch-by-four-inch, of the 07292024 sample were cut with a precision die and used in the test. Four, eight-inch diameter, clear, settling columns, were set up with 115 cm timing marks, with the lower timing mark located 30 cm above the bottom of the columns. Valves are located in the middle and at the bottom of the columns to facilitate ease of dispensing one liter of water to introduce the sample product, and to drain and clean the columns at the conclusion of testing. Stainless steel wire mesh baskets are located at the bottom of the settling column attached to fifty-pound test line weighted with stainless steel washers, to keep the lines against the column so as not to interfere with the test. The bag samples were not stirred for thirty seconds in twenty liters of 22° C.±3° C. tap water prior to introduction into the settling column due to the fact that this would cause them to dissolve. Instead, the sample were directly added to 1L of water from the settling column and dumped gently into the settling column. Since the samples dissolved during this process, the time recorded was not when they passed by the 115-cm mark but when they were completely dissolved. This is a deviation from the method, but actual settling time was impossible to determine due to the nature of the samples. The ten replicate samples were analyzed and allowed to settle for twenty-four hours, to see if any samples rose above the thirty-cm mark. There was one round of testing, based on the performance of the sample.

The Average Settling Velocity of the 07292024 samples was greater than the 0.1 cm/sec minimum requirement for FG504-Settling Test method, at least 95% of the bags settled to the base of the column, and at least 95% of the ten wipe samples did not rise above the bottom 30 cm mark after twenty-four hours. The results are summarized in Table 4.

### Test Description

| Determination Type | Tap Water-1 |
|---|---|
| Sample Description | 07292024 |
| Sheets | 10 |
| Dimensions | 4″ × 4″ |
| Settling distance (cm) | 115 |

TABLE 4
FG504- Settling Test Summary- 07292024
Test start date Aug. 6, 2024
Sample ID 01322-24-001

| Replicate | Time (sec.) | Vel. (cm/sec) |
|---|---|---|
| 1 | 72.12 | 1.59 |
| 2 | 60.24 | 1.91 |
| 3 | 81.81 | 1.41 |
| 4 | 91.23 | 1.26 |
| 5 | 75.65 | 1.52 |
| 6 | 83.63 | 1.38 |
| 7 | 66.98 | 1.72 |
| 8 | 74.12 | 1.55 |
| 9 | 90.36 | 1.27 |
| 10 | 86.56 | 1.33 |
| Average | 78.27 | 1.49 |
| Percent failed to settle | 0% | |
| Percent settled (24 hrs.) | 100% | |
| Comments | Pass | |
| Test Start | Aug. 6, 2024 | |
| Air Temp (° C.) | 21.0° C. | |
| Water Temp (° C.) | 20.8° C. | |
| Test End - 24 hr. | Aug. 7, 2024 | |
| Air Temp (° C.) | 21.0° C. | |
| Water Temp (° C.) | 20.9° C. | |

### Example 2D: Anaerobic Bio-Disintegration Test (GD4)

The anaerobic bio-disintegration test determines the percent of a product (sample #07292024) that disintegrates to less than 1 mm after being incubated for 28 days in anaerobic digester sludge. This test can be used to assess the potential for a product to biologically disintegrate under anaerobic conditions found in sewers as well as municipal and onsite wastewater treatment systems. The sample was rinsed in 22° C.±3° C. tap water for thirty seconds, prior to introduction into 1.5 liters of activated anaerobic digester sludge from the City of Appleton Wastewater Treatment plant in Appleton, WI. The sludge was strained through a one mm stainless steel sieve. The pH was taken and determined to be in the acceptable range of 6 to 9 pH units. The Total Solids (TS) were determined gravimetrically and was found to be 37,337 mg/L. Since the sludge should be in the range of 8000-10000 mg/L, the sludge was volumetrically diluted with untreated wastewater that was strained through a two-mm stainless steel sieve to be within the acceptable range. During this process, the sludge had limited exposure to the atmosphere by sealing the sludge bucket with an airtight lid. 1.5 liters of sludge were transferred into one half gallon glass jugs and the bag sample was placed in the sludge in triplicate. A blank and two USP 100% cotton controls were also treated in the same manner. Fermentation airlocks filled with water were inserted into the vessel neck and the glass jugs were placed in a Precision Scientific Co. Freas 815 incubator set at 35° C.±3° C. The incubator temperature was monitored on a daily basis and the samples were incubated for twenty-eight days according to the method.

After fourteen days, one of the cotton controls was poured through a one mm sieve and rinsed with tap water for two minutes at a rate of four liters per minute, to determine whether the sludge was active enough. After fourteen days, the first cotton control was 100% bio-disintegrated, indicating that the sludge was biologically active for the study. After twenty-eight days, the blank, cotton control, and samples were each poured through a one mm sieve and rinsed with tap water for two minutes at a rate of four liters per minute. The remaining solids were placed in a tared, aluminum weighing dish and dried at 105° C. in an oven for at least two hours. The results are tabulated below in Table 5. The 07292024 sample passed the criteria of greater than 95% of the material passing through the 1 mm sieve after twenty-eight days.

TABLE 5
FG506A Anaerobic bio-disintegration-07292024

| Day # | Incub. Temp (° C.) | Day # | Incub. Temp (° C.) |
|---|---|---|---|
| 1 | 35.0° C. | 15 | 35.0° C. |
| 2 | 35.0° C. | 16 | 35.0° C. |
| 3 | 35.0° C. | 17 | 35.0° C. |
| 4 | | 18 | |
| 5 | | 19 | |
| 6 | 35.0° C. | 20 | 35.0° C. |
| 7 | 35.0° C. | 21 | 35.0° C. |
| 8 | 35.0° C. | 22 | 35.0° C. |
| 9 | 35.0° C. | 23 | 35.0° C. |
| 10 | 35.0° C. | 24 | 35.0° C. |
| 11 | | 25 | |
| 12 | | 26 | |
| 13 | 35.0° C. | 27 | |
| 14 | 36.0° C. | 28 | 35.0° C. |
| Average | 35.1° C. | | |
| SD | 0.2294 | | |

TABLE 6
Anaerobic digester sludge was obtained
from: City of Appleton, pH = 7.21

| | A | B | C |
|---|---|---|---|
| Tare Wt. (g) | 1.2748 | 1.2769 | 1.2785 |
| Initial Wt. (g) | 5.4263 | 5.2538 | 5.3256 |
| Dried Wt. (g) | 1.4301 | 1.4255 | 1.4292 |
| % total solids | 3.7408 | 3.7366 | 3.7237 |
| | | Average | 3.7337 |
| | | SD | 0.0089 |

| | | | Final | | | |
|---|---|---|---|---|---|---|
| | | Initial | Wt. | % Wt | | |
| Sample | Final Date | Wt. (g) | (g) | Loss | Comments | |
| Blank | Sep. 3, 2024 | 1.0000 | 0.0000 | 100.00 | | |
| Control 1 | Aug. 20, | 1.0526 | 0.0000 | 100.00 | Average | 100.0% |
| | 2024 | | | | | Pass |
| Control 2 | Sep. 3, 2024 | 1.0458 | 0.0000 | 100.00 | SD | 0 |
| 01322- | Sep. 3, 2024 | 4.8345 | 0.0000 | 100.00 | Average | 100.0% |
| 24-01a | | | | | | Pass |
| 01322- | Sep. 3, 2024 | 4.8345 | 0.0000 | 100.00 | SD | 0 |
| 24-01b | | | | | | |
| 01322- | Sep. 3, 2024 | 4.8345 | 0.0000 | 100.00 | | |
| 24-01c | | | | | | |
| | Control Ave | 1.0492 | | | | |
| | Control SD | 0.0048 | | | | |

### Example 2E: Analysis of Article (Dog Waste Bag)

Infrared spectroscopy was used to analyze the composition of a single dog waste bag sample (07292024). The sample, which was a colorless film, was analyzed using Microscopic Attenuated Total Reflectance Infrared Spectroscopy (MicroATR). MicroATR analyzes the surface of a sample at a depth of approximately 1-2 microns and each resulting spectrum represents a surface area of less than 0.1 mm². Both the inside and outside of three bag specimens were analyzed. Because MicroATR analyzes only the surface of the sample, this analysis could not determine whether the poly film was of single or multilayer construction. Slight variations in composition across the sample surfaces could lead to variations in the resulting spectra, and therefore, the reported spectra might not be representative of the entire sample.

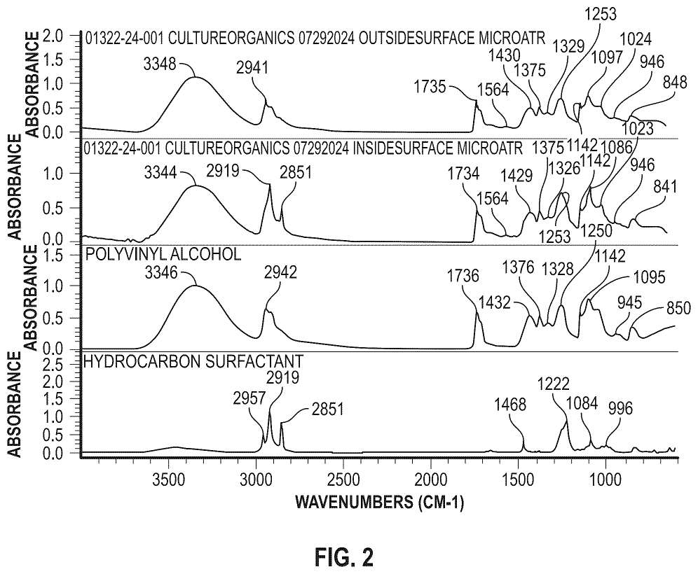

Analysis results were obtained with the assistance of infrared spectroscopy matching software, which compares and ranks the sample spectra against IR reference library spectra. (Note: Sample identification may depend on whether matching spectra are included in the SGS-IPS IR reference libraries.) Results, listed in Table 7, are the best library matches for the sample analyzed and are examples of the types of compounds indicated by the sample spectra. Representative spectra is shown in FIG. 2.

All resulting spectra as seen in FIG. 2, from both sides of the sample were consistent with polyvinyl alcohol. Some spectra had additional peaks near wavenumbers 2919 cm−1 and 2851 cm−1. Peaks in this area indicate the presence of a long chain hydrocarbon compound, such as surfactants, waxes, and fatty acid compounds. Polyethylene would also give peaks in this region. This analysis could not identify the exact hydrocarbon present on the surface of the film, however, variation in the relative peak intensity from one test location to another suggests the detected hydrocarbon could be a processing aid/slip agent.

An additional specimen was tested to help determine whether the detected hydrocarbon could be a processing aid on the surface of the film. Several Kimwipes were dipped in hexane and used to wipe both sides of a film specimen. Spectra were acquired from the wiped film and observed for the presence of peaks near wavenumbers 2919 cm⁻¹ and 2851 cm⁻¹. Resulting spectra (figure not provided) had either very minor or no peaks in this region, suggesting the hydrocarbon component had been removed by the hexane and that the detected hydrocarbon was a possible processing aid/slip agent.

### Example 3: Material Characteristics of Sugarcane PVA Resin (Granular)

Test item: A visual presentation of Sugarcane PVA Resin Granular Code: 2024RSG.

### 3.1 Volatile Solids Content

A minimum volatile solids content of 50% on total solids (TS) is prescribed by following standard specifications:

EN 13432 Requirements for packaging recoverable through composting and biodegradation-Test scheme and evaluation criteria for the final acceptance of packaging (2000); ASTM D6400 Standard Specification for Labeling of Plastics Designed to be Aerobically Composted in Municipal or Industrial Facilities (2023); CAN/BNQ 0017-088 Specifications for compostable plastics (2010); ISO 18606 Packaging and the environment—Organic recycling (2013).

The dry matter of the test item is determined by drying at 105° C. for at least 14 hours. After cooling down in a desiccator, the moisture content is determined by the total amount of weight loss, as described in ‘M_009. Determination of dry matter, moisture content and residual moisture content. The dry matter is given in percentage on wet weight.

The volatile solids and ash content is determined by incinerating the dried sample at 550° C. for at least 4 hours, as described in ‘M_010. Determination of organic matter and carbon content’. The ash is then determined as the residue on ignition. The organic matter is taken to be the loss of mass on ignition. Both parameters are expressed as percentage by mass of the dried sample (Table 8).

### 3.2 Heavy Metals

### Limit Values and Test Methods

Following standard specifications define limit levels for heavy metals:

EN 13432 Requirements for packaging recoverable through composting and biodegradation-Test scheme and evaluation criteria for the final acceptance of packaging (2000); ASTM D6400 Standard Specification for Labeling of Plastics Designed to be Aerobically Composted in Municipal or Industrial Facilities (2023); CAN/BNQ 0017-088 Specifications for compostable plastics (2010).

The international standard ISO 18606 Packaging and the environment—Organic recycling (2013) prescribes that the concentrations of regulated metals and other toxic substances in the product shall not exceed the limits specific to the country where the final product will be placed on the market or disposed of. The limit values and test procedures are given in Table 9.

### Determination of Cadmium, Cobalt, Copper, Chromium, Molybdenum, Nickel, Lead and Zinc

Cadmium, cobalt, copper, chromium, molybdenum, nickel, lead and zinc are digested according to ‘M_059 Microwave Assisted Digestion for Subsequent Determination of Elements’ and analyzed according to ‘M_060 Determination of Selected Elements in Microwave Digest Solutions by Inductively Coupled Plasma Optical Emission Spectrometry’.

### Determination of Arsenic, Selenium and Mercury

Arsenic, selenium and mercury are digested according to ‘M_059 Microwave Assisted Digestion for Subsequent Determination of Elements’ and analyzed according to ‘M_061 Determination of Hydride Forming Elements by Inductively Coupled Plasma Optical Emission Spectrometry.’

### 3.3 Fluorine

Following standard specification defines a limit level for fluorine:

EN 13432 Requirements for packaging recoverable through composting and biodegradation-Test scheme and evaluation criteria for the final acceptance of packaging (2000).

The limit value and test procedure are given in Table 9. The fluorine content is determined by an external lab.

### 3.4 Infrared Analysis

### Principle

Infrared Spectroscopy is a qualitative method that indicates the presence of particular functional groups in a test item. The percentage transmission or absorbency of a test item at different wavelengths is recorded which results in a typical infrared spectrum of that material. Each material has its own infrared spectrum.

### Apparatus

The infrared spectra are obtained with a Nicolet iS20 FT-IR Spectrometer (Thermo Fisher). The spectrometer is equipped with a diamond crystal ATR. The spectrum is measured in the range of 400 cm−1 to 4000 cm−1 with a resolution of 4 cm−1, 16 scans are taken.

### Method and Interpretation

A small amount of the test item is placed in a sample holder and introduced in the apparatus. First an IR spectrum of the sample holder without test item is taken in order to obtain a background signal.

When a compound absorbs radiation at a particular wavelength, the intensity of radiation being transmitted decreases. This results in a decrease in % R and appears in the spectrum as a dip, called an absorption peak, or absorption band. Different functional groups have typical ranges of wavelengths of absorption. Each test item has its own typical infrared spectrum.

### Results

### 3.1 Volatile Solids Content

The total solids content (TS), the moisture content, the volatile solids content (VS) on total solids and the ash content on total solids of the test item are shown in Table 8. EN 13432 (2000), ASTM D6400 (2023), CAN/BNQ 0017-088 (2010) and ISO 18606 (2013) prescribe a minimum volatile solids content of 50% on TS.

Test item Sugarcane PVA Resin Granular Code: 2024RSG with a volatile solids content of 99.6% on TS easily fulfills this requirement.

TABLE 8
Total solids content, moisture content, volatile
solids content and ash content of the test item

| | Sugarcane PVA Resin |
|---|---|
| Characteristics | Granular Code: 2024RSG |
| Total solids (TS, %) | 85.5 |
| Moisture content (%) | 14.5 |
| Volatile solids (VS, % on TS) | 99.6 |
| Ash content (% on TS) | 0.4 |

### 3.2 Heavy Metals and Fluorine

The heavy metals content and the fluorine content of Sugarcane PVA Resin Granular Code: 2024RSG are given in Table 9, together with the limit values as prescribed by EN 13432 (2000), ASTM D6400 (2023) and CAN/BNQ 0017-088 (2010). All values lay well below the maximum levels as prescribed by the standards.

TABLE 9
Heavy metals and fluorine content (ppm on total solids)

| | | Limit values | | | |
|---|---|---|---|---|---|
| | | | | Canada | |
| | Sugarcane PVA | Europe | USA** | CAN/BNQ | |
| | Resin Granular | EN 13432 | ASTM D6400 | 0017-088 | Test |
| Analysis | Code: 2024R SG | (2000) | (2023) | (2010) | procedure |

Heavy metals*

| | | | | | | |
|---|---|---|---|---|---|---|
| As | <1.00 | ≤5 | <20.5 | <9.5 | | NBN EN |
| | | | | | | ISO 11885 |
| Cd | <0.40 | ≤0.5 | <19.5 | <2.5 | | NBN EN |
| | | | | | | ISO 11885 |
| Co | <2.00 | — | — | <19 | | NBN EN |
| | | | | | | ISO 11885 |
| Cr | <5.00 | ≤50 | — | | <132.5 | NBN EN |
| | | | | | | ISO 11885 |
| Cu | <5.00 | ≤50 | <750 | | <94.5 | NBN EN |
| | | | | | | ISO 11885 |
| Hg | <0.10 | ≤0.5 | <8.5 | <0.5 | | NBN EN |
| | | | | | | ISO 11885 |
| Mo | <0.50 | ≤1 | — | <2.5 | | NBN EN |
| | | | | | | ISO 11885 |
| Ni | <5.00 | ≤25 | <210 | | <22.5 | NBN EN |
| | | | | | | ISO 11885 |
| Pb | <25.0 | ≤50 | <150 | | <62.5 | NBN EN |
| | | | | | | ISO 11885 |
| Se | <0.75 | ≤0.75 | <50 | <2 | | NBN EN |
| | | | | | | ISO 11885 |
| Zn | <20.0 | ≤150 | <1400 | | <231.5 | NBN EN |
| | | | | | | ISO 11885 |

Fluorine

| | | | | | |
|---|---|---|---|---|---|
| F | <10 | ≤100 | — | — | DIN 51723 |
| | | | | | mod. |

*Microwave digestion was executed on the sample according to DIN EN 13656 Mod. for all heavy metals
**Maximum levels for USA (according to ASTM D6400 (2023) heavy metals content must be less than 50% of those prescribed for sludges or composts in the country where the product is sold; specifically in the United States, the regulated metal concentrations are found in Table 3 of 40 CFR Part 503.13)

### 3.3 Infrared Analysis

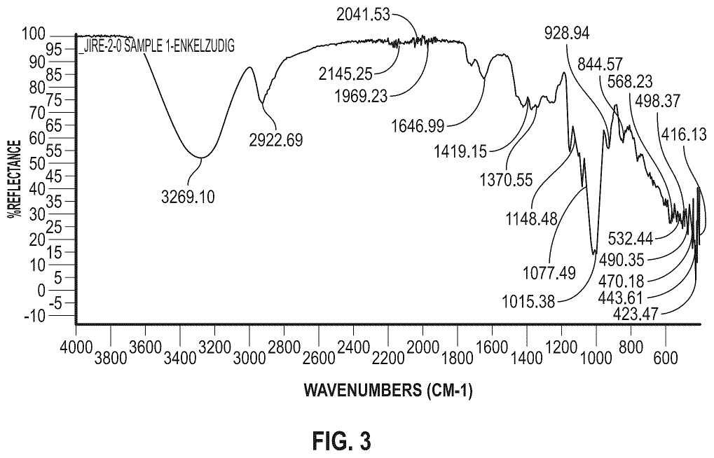

The ATR-IR spectrum of test item Sugarcane PVA Resin Granular Code: 2024RSG is given in FIG. 3.

### Summary and Conclusions

From the results it can be concluded that test item Sugarcane PVA Resin Granular Code: 2024RSG fulfills: the requirement on volatile solids as defined by EN 13432 (2000), ASTM D6400 (2023), CAN/BNQ 0017-088 (2010) and ISO 18606 (2013); the requirements on heavy metals as defined by EN 13432 (2000), ASTM D6400 (2023) and CAN/BNQ 0017-088 (2010); the requirement on fluorine as defined by EN 13432 (2000).

### Example 4: Test Report for PVA Sugarcane Pallet Wrap and Resin

Product Description: Cultural Organics LLC's PVA sugarcane pallet wrap and its resin are bio-based packaging materials designed to provide an eco-friendly alternative to conventional plastic wraps. The wrap is primarily made from sugarcane, a renewable resource, and offers superior moisture barrier properties.

Purpose of Testing: The objective of this test is to evaluate the carbon footprint, moisture content, and shelf life of the PVA sugarcane pallet wrap and its resin.

Test Summary Table

| | | | PVA | PVA |
|---|---|---|---|---|
| | Passing | Failing | Sugarcane | Sugarcane |
| Test Type | Value | Value | Wrap | Resin |
| Carbon | ≤1.5 kg | ≥5.0 kg | 2.0 kg | 2.0 kg |
| Footprint | CO2e/kg | CO2e/kg | CO₂e/kg | CO₂e/kg |
| | | | (Pass) | (Pass) |
| Moisture | WVTR < 10 | WVTR > 20 | WVTR = 8 | WVTR = 8 |
| Barrier | g/m²/day | g/m²/day | g/m²/day | g/m²/day |
| | | | (Pass) | (Pass) |
| Shelf Life | ≥12 months | <6 months | 14 months | 14 months |
| | | | (Pass) | (Pass) |
| Moisture | <0.5% | >1.5% | 0.3% | 0.3% |
| Content | | | (Pass) | (Pass) |

### Carbon Footprint Test

Testing Methodology: Life Cycle Assessment (LCA) was used to calculate the carbon footprint.

### Results:

Wrap: 2.0 kg CO₂e per kilogram of wrap (Pass)
Resin: 2.0 kg CO₂e per kilogram of resin (Pass)

### Moisture Barrier:

Test Testing Standard: ASTM E96 (Standard Test Methods for Water Vapor Transmission of Materials).

### Results:

$$Wrap : WVTR = 8 g / m 2 / day ( Pass )$$

$$Resin : WVTR = 8 g / m 2 / day ( Pass )$$

### Shelf Life Test

Storage Conditions: Samples were stored at room temperature (23° C.±2° C.) and 50% relative humidity.

Testing Date: Testing began on Jan. 1, 2024, and concluded on Feb. 1, 2025.

### Results:

Wrap: 14 months (Pass)
Resin: 14 months (Pass)

### Moisture Content Test

Testing Standard: ASTM D6980 (Standard Test Method for Determination of Moisture in Plastics by Loss in Weight).

### Results:

Wrap: 0.3% (Pass)
Resin: 0.3% (Pass)

| | |
|---|---|
| Markdown | Copy |

**Performance Comparison**

| Test Type | PVA Sugarcane Wrap | PVA Sugarcane Resin |
|---|---|---|
| ---------------------------- | ---------------------------- | ---------------------------- |
| -------- | -------- | -------- |
| Carbon Footprint | Pass | Pass |
| Moisture Barrier | Pass | Pass |
| Shelf Life | Pass | Pass |
| Moisture Content | Pass | Pass |

The above test results confirm that both Cultural Organics LLC's PVA sugarcane pallet wrap and its resin meet the required standards for carbon footprint, moisture barrier, shelf life, and moisture content, demonstrating their effectiveness and reliability as eco-friendly packaging materials.

Although the invention has been described with reference to the disclosed embodiments, those skilled in the art will readily appreciate that the specific examples and studies detailed above are only illustrative of the invention. It should be understood that various modifications may be made without departing from the spirit of the invention.

1. A polymer composition comprising polyvinyl alcohol (PVA), and water;
further comprising one or more optional additives;
wherein the PVA is obtained from sugarcane; and wherein the article is completely water soluble.

2. The polymer composition of claim 1, comprising 75-85% PVA, and 15-25% of water; or 70-90% PVA, and 10-30% of water; or 80% PVA, and 20% of water or 90% PVA, and 10% of water.

3. The polymer composition of claim 1, comprising a melt index (I₂) in a range of from 1 to 5 g/10 minutes and a molecular weight distribution (M_{w}/Mₙ) in the range of from 1.2 to 2 g/mol.

4. The polymer composition of claim 1, wherein the polymer composition is stable between about 50° F. to 160° F.

5. The polymer composition of claim 1, wherein the polymer composition is recognized as Generally Recognized as Safe (GRAS).

6. An article manufactured using the composition of claim 1.

7. The article of claim 6, comprising grocery bags, dog waste collection bags, produce bags, gloves, packaging materials, films, shrink wrap films, pallet wraps, meat trays, clamshells, lunch trays, agricultural films, laundry pod shells, consumable medical products, or drug capsule shells.

8. The article of claim 6, wherein the pallet wrap has a moisture vapor transmission rate (WVTR) of less than 10 g/m²/day.

9. The article of claim 6, wherein the pallet wrap has a moisture content of less than 0.5%.

10. The article of claim 6, wherein the pallet wrap has a carbon footprint of 2.0 kg CO₂e per kilogram of wrap.

11. The article of claim 6, wherein when the article is dissolved in a water solution, the water solution comprising the article is free of microplastics.

12. A biodegradable collection bag comprising a multilayer film, further comprising at least one layer of a polymer composition;
wherein the polymer composition is about 65% to about 95% by weight of polyvinyl alcohol (PVA); wherein the PVA is sourced fully or partially from sugarcane or a derivative thereof; and wherein the bag has a thickness of about 5 to 500 μm.

13. The biodegradable collection bag of claim 12, further comprising an additional agent comprising a filler, a natural polymer material, or a plasticizer wherein the additional agent is present in any of the layers of the multilayer film.

14. The biodegradable collection bag of claim 13, wherein the filler comprises olefin, polyethylene wax, silicon dioxide, talcum powder, calcium carbonate, magnesium carbonate, magnesium hydroxide, calcium stearate, titanium dioxide, lithopone, magnesium stearate, octadecanamide, stearic acid, or a combination thereof.

15. The biodegradable collection bag of claim 13, wherein the natural polymer material is cellulose, polylactic acid soluble cornstarch, cassava, xylogen, starch, chitin, chitosan, a polysaccharide modifier, or a combination thereof.

16. The biodegradable collection bag of claim 13, wherein the plasticizer comprises glycerol, diglycerol, polyethylene glycol, polypropylene glycol, caprolactam, trimethylolpropane, water, sorbitol, or a combination thereof.

17. The biodegradable collection bag of claim 12, wherein the collection bag is toilet-flushable type.

18. The biodegradable collection bag of claim 12, wherein the collection bag disintegrates under anaerobic conditions in 28 days.

19. The biodegradable collection bag of claim 12, wherein the collection bag disintegrates in water with mechanical agitation.

20. The biodegradable collection bag of claim 12, wherein a water solution comprising the biodegradable collection bag is ≥98% free of microplastics.
